(19) United States
(12) Patent Application Publication
(10) Pub. No.: US 2008/0095594 A1
(43) Pub. Date: Apr. 24, 2008

(54) Screw

(76) Inventors: Ching-Guei Lin, Lujhu Township (TW); Mau-Chang Wu, Lujhu Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/585,153

(22) Filed: Oct. 24, 2006

(51) Int. Cl. F16B 35/04

(52) U.S. Cl. 411/411

(57) ABSTRACT

The present invention relates to a screw with the distal end forming a cone-shaped portion, and a first and a second thread segment defined on the shank and the cone-shaped tip portion. Moreover, the first thread segment forms a thread peak and the second thread segment forms a plane surface; besides, said plane surface converges toward the thread peak of the first thread segment. Therefore, at the beginning of screwing, said plane surface of the second thread segment drills into the object to enlarge the channel. Since the channel is enlarged, the second thread segment can enter the object with less friction and higher screwing speed. Besides, the cutting debris can be removed from the space between the enlarged channel and the first thread segment to avoid cracking in the object and to maintain a better effect on fastening.

### BACKGROUND OF THE INVENTION

1. Field of the Invention

The present invention relates to a screw, in particular to a screw with lower screwing torque and higher screwing speed.

2. Description of the Related Art

A conventional screw 1 disclosed in FIG. 1 generally comprises a head 11, a shank 12 extending therefrom, and a plurality of threads spirally connected to the shank along with the shank axial line “a”. While the screw 1 is screwed into the object 2 (e.g. a plastic board), thereby the shank 12 digging onto the object 2 to apply a screw torque on the head 11 to rotate the thread 13 sharp cutting the object 2, and make the screw 1 screw into the object 2 gradually. However, it is found that while the prior art screw 1 is screwing into the object 2, the cutting debris can not be eliminated from the object 2 successfully, therefore to generate the screwing resistance while the thread 13 are screwed. In addition, it causes a large screw torque for the screw 1; therefore, it needs to apply more screwing torque during operation. In comparative, the screwing speed will be lower due to the afore mentioned influence.

### SUMMARY OF THE INVENTION

Accordingly, the present invention is in particular to a screw that provided with the lower screwing torque and higher screwing speed. Therefore, the present invention relates to a screw that comprises a head, a shank extending from the head, and a plurality of threads spirally connected to the shank along with the shank axial line “α”; and a first thread section is spirally defined on the shank; wherein said shank forms a cone-shaped tip portion and taper off to the distal end. The first thread section and the cone-shaped tip portion have a first thread segment and a second thread segment spirally connected to the shank; besides, each of the first thread segment forms a thread peak thereof and the second thread forms a plane surface thereof. Finally, the plane surface converges toward the thread peak connecting to the shank gradually.

Therefore, at the beginning of screwing, the plane surface on the second thread segment screws into the object to enlarge the screwing channel. Since the channel is enlarged, the first thread segment can enter the object with less friction and higher speed. Besides, the cutting debris can be eliminated from the space between the enlarged channel and the first thread segment, so as to lower the screwing torque, to avoid the crack in the object, and to maintain a better effect at screwing.

The present invention will become more obvious from the following description when taken in connection with the accompanying drawings which shown, for purposes of illustration only, a preferred embodiment in accordance with the present invention.

### BRIEF DESCRIPTION OF THE DRAWINGS

FIG. 1 is a schematic diagram showing a conventional screw screwing into the object.

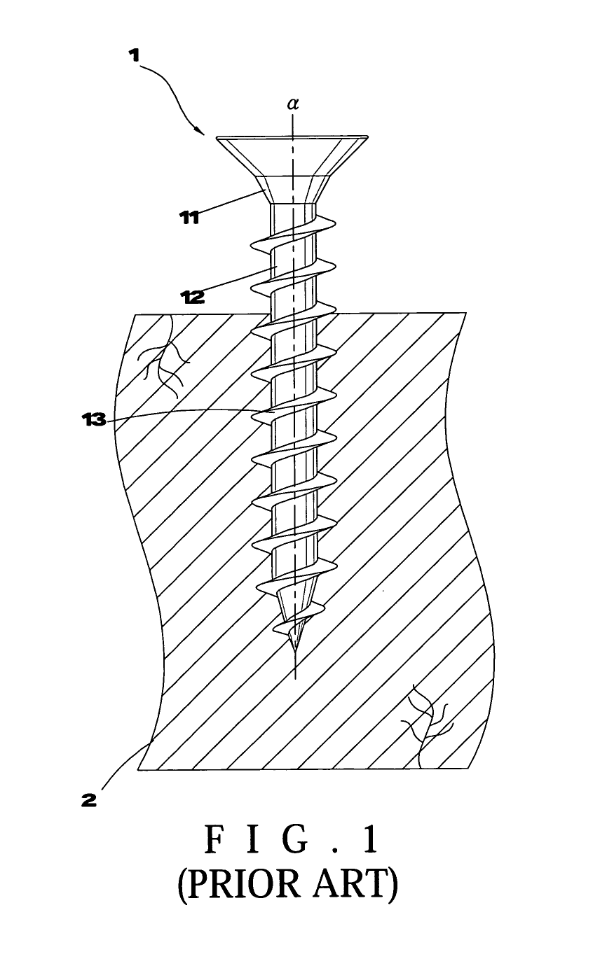

FIG. 2 is a schematic diagram showing the first preferred embodiment of the present invention;

FIG. 3 is a schematic diagram showing the second preferred embodiment of the present invention;

FIG. 4 is a cross section diagram of the first preferred embodiment screwed into an object;

FIG. 5 is a cross section diagram of the third preferred embodiment screwed into an object; and

FIG. 6 is a schematic view showing that the fourth preferred embodiment of the present invention.

### DETAILED DESCRIPTION OF THE PREFERRED EMBODIMENTS

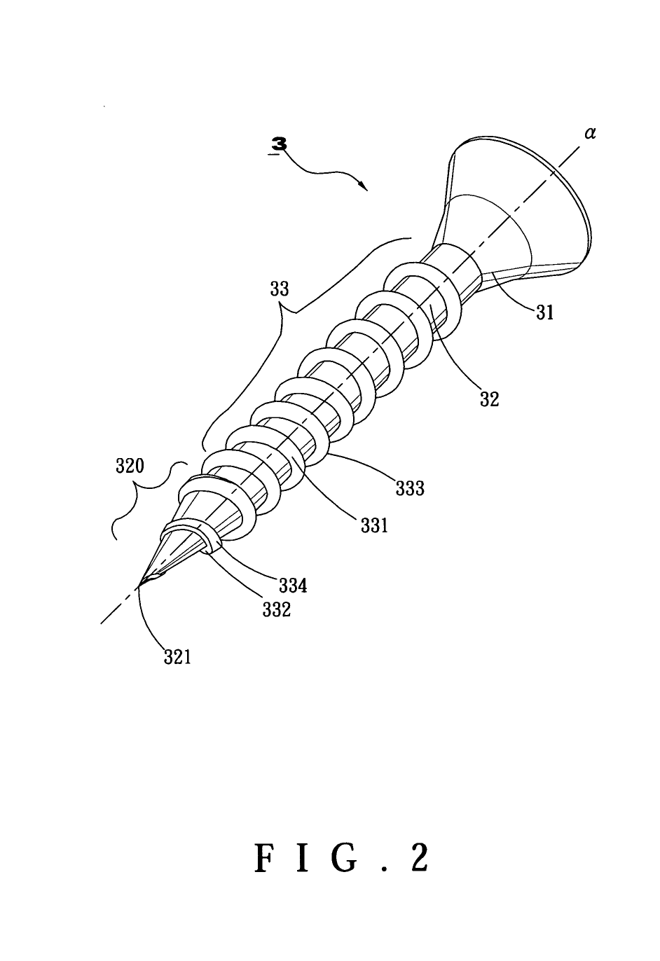

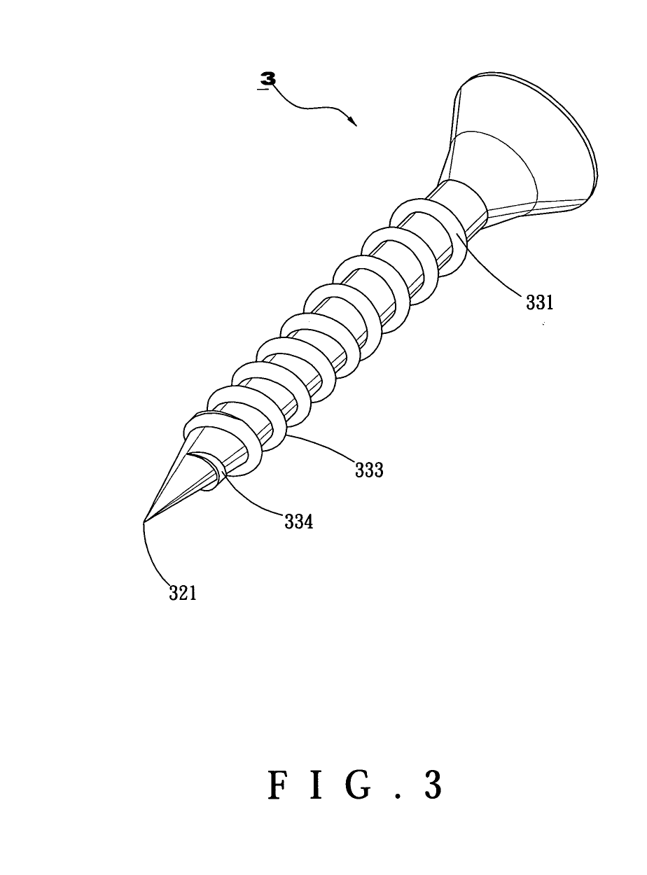

Referring to FIG. 2, the first preferred embodiment of the present invention comprises a head 31, a shank 32 which connected to the head 31, and a first thread section 33 spirally connected to the shank 32 along with the shank axial line “α”; wherein the head 31 is defined with recesses for the screwdriver to screw. Moreover, the recesses are sorts of Phillip, slotted, and many different kinds of shape according to the user's need, so as to fit in with different kinds of screwdriver. Besides, the distal end of the shank 32 forms a cone-shaped tip portion 320 and the cone-shaped tip portion 320 forms a drill point 321; furthermore, wherein the first thread section 33 has a first thread segment 331 and a second thread segment 332 spirally defined on the shank 32 and the cone-shaped tip portion 320. Each thread of first thread segment 331 forms a thread peak 333 thereon. Furthermore, the outer diameter of the thread at second thread segment 332 is shorter than the outer diameter of the first thread segment 331; meanwhile, the second thread segment 332 can depend on the user's needs to extend upwardly from the drill point 321 or from a non-drill point part (referring to FIG. 3), and here is an example of the second thread segment 332 extending upwardly from the drill point 321. Besides, the thread of the second thread segment 332 forms a plane-surface 334 thereon, and the plane-surface 334 is converged toward the thread peak 333 of the first thread segment 331.

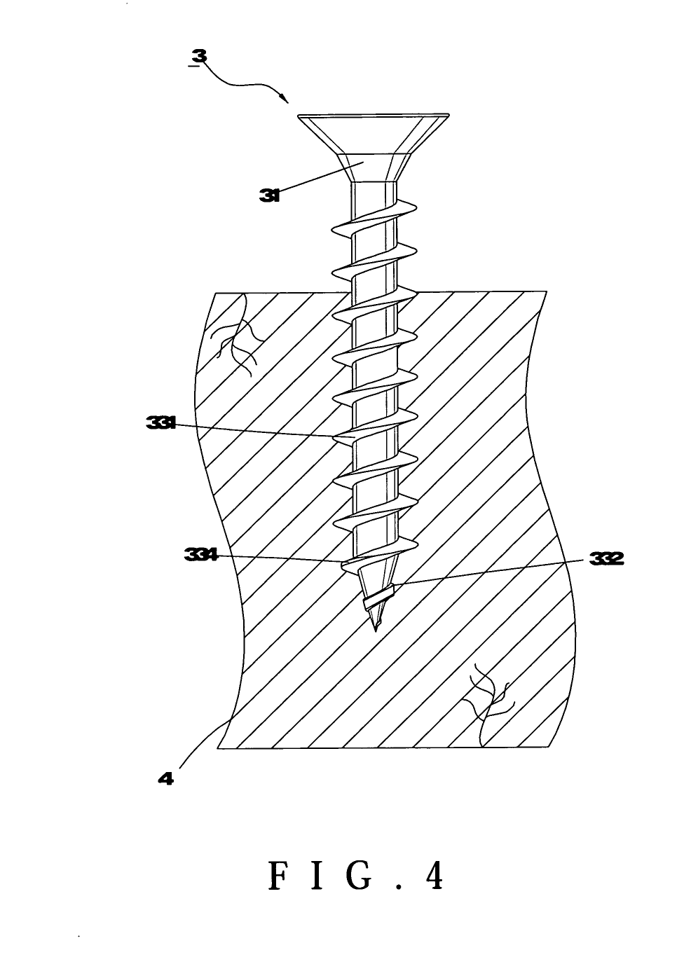

Referring to FIG. 4, a screwing torque is applied on the head 31 while screwing, therefore to tug the second thread segment 332 sharper cutting the object 4. Moreover, the object 4 is a mixture material made by wood scrap, rubber, and adhesive, and further to illustrate with a high-pressure formed object. The plane surface 334 of the second thread segment 332 drills into the object 4 to enlarge the screwing channel. Since the channel is enlarged, the first thread segment 331 can enter the object 4 efficiently with the enlarged channel to lower the screwing torque. Furthermore, after the second thread segment 332 drills into the object 4, the cutting debris can be eliminated from the space between the enlarged channel and the first thread segment 331, therefore to avoid crack in the work piece, to enhance the screwing speed, and to lower the screwing torque during operation. Since the cutting debris is eliminated from the space between the enlarged channel and the first thread segment 331, the left debris can be filled into the channel and can achieve the fastening effect.

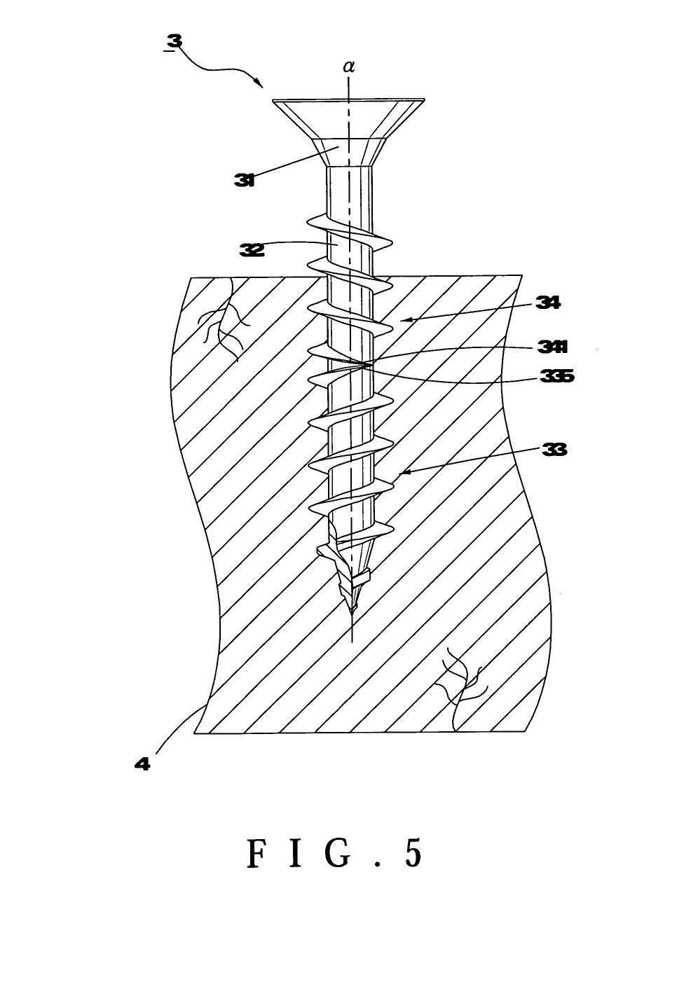

Referring to FIG. 5, the third preferred embodiment of the present invention, same as the explanation in the first embodiment, comprises a head 31, a shank 32 connected to the head 31, and a first thread section 33 spirally connected to the shank 32 along with the axial line “α”; in particular, thereon the shank 32 between the head 31 and the first thread section 33 is defined with a second thread section 34 which is deposed in reverse direction to the first thread section 33. Besides, the start point 341 of the second thread section 34 is engaged with the end point 335 of first thread section 33. In screwing the screw, by means of the second thread section 34 is disposed in the reverse direction, and the start point 341 of the second thread section 34 is engaged with the end point 335 of the first thread section 33, the cutting debris can be removed efficiently. Further, the second thread section 34 fills in the space with part of the cutting debris, so as to enhance the fastening effect. Consequently, the first thread 33 and the second thread section 34 subdue to each other so as to avoid the screw being loosen.

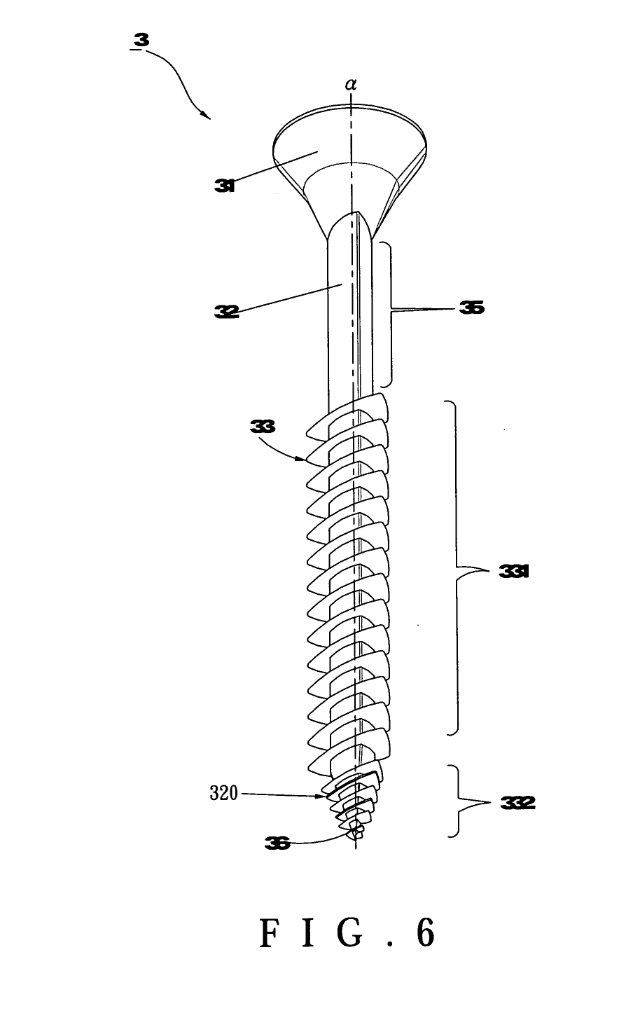

Referring to FIG. 6, the fourth preferred embodiment of the present invention comprises a head 31, a shank 32 connected to the head 31, and a first thread section 33 spirally connected on the shank 32 along with the shank axial line “α”. In particular, said shank 32 and the first thread section 33 are formed of a triangular shape. Beside, there between the first thread section 33 and the head 31 is defined with a smooth section 35; further, the cone-shaped tip portion 320 forms a auxiliary third thread section 36 extending upwardly among each thread of the second thread segment 332, and the auxiliary third thread section 36 is formed of triangular shape. Moreover, Due to the shank 32, the first thread section 33 and the auxiliary third thread 36 forming a triangular shape, the contacting area with the object 4 is reduced and the friction torque from the screwing operation is lower; therefore to enhance the anti-loosen effect by screwing the auxiliary third thread section 36 and to avoid the cladding material which platting on said shank falling off. In addition, the cladding material on the screw 3 is efficient at anti-rust and isolation.

To sum up with above description, the present invention provides a plane-surface defined on the thread connecting to the cone-shaped tip portion, so as to drill into the object 4 to enlarge the screwing channel. It benefits at lowering screw torque and enhancing better effects on fastening. Finally, accompanying with the shank and the threads formed of triangular shape, the friction force between the screw and the object can be lower, and therefore to enhance the anti-rust and isolation effect.

While we have shown and described the embodiment in accordance with the present invention, it should be clear to those skilled in the art that further embodiments may be made without departing from the scope of the present invention.

I claim:

1. A screw comprising:
a head, a shank longitudinally extending from said head; and a first thread section spirally connected to the shank; wherein the distal end of said shank forms a cone-shaped tip portion and tapering off to form a drill point. (Besides, the first thread section has a first thread segment and a second thread segment spirally defined on the shank and the cone-shaped tip portion); further, each thread of first thread segment forms a thread peak and each thread of second thread segment forms a plane surface thereon. Said the plane surface converges toward the thread peak of the first thread segment.

2. The screw as claimed in claim 1, wherein the second thread section is defined on the shank between the screw head and the first thread section; further, the second thread section and the first thread section are disposed in reverse direction, and the start point of second thread section is engaged with the end point of the first thread section.

3. The screw as claimed in claim 1, wherein said the second thread segment extends upwardly from the drill point to engage with the first thread segment.

4. The screw as claimed in claim 1, wherein said shank is formed of triangular shape.

5. The screw as claimed in claim 1, the first thread section is formed of triangular shape.

6. The screw as claimed in claim 1, there (between) the screw head and the first thread section is defined with a smooth area.

7. The screw as claimed in claim 1, thereon said cone-shaped tip portion forms a auxiliary third thread section extending upwardly and spirally defined among each second thread.
